(19) United States
(12) Patent Application Publication
(10) Pub. No.: US 2010/0310447 A1
(43) Pub. Date: Dec. 9, 2010

(54) CARBON-CONTAINING MATRIX WITH FUNCTIONALIZED PORES

(75) Inventors: Zvi Yaniv, Austin, TX (US); Nan Jiang, Austin, TX (US); James Novak, Austin, TX (US)

Correspondence Address: LEE & HAYES, PLLC, 601 W. RIVERSIDE AVENUE, SUITE 1400, SPOKANE, WA, 99201, US

(73) Assignee: Applied Nanotech, Inc., Austin, TX (US)

(21) Appl. No.: 12/793,659

(22) Filed: Jun. 3, 2010

Related U.S. Application Data
(60) Provisional application No. 61/184,549, filed on Jun. 5, 2009.

(51) Int. Cl. C01B 31/02; C01B 31/04; C01B 31/08

(52) U.S. Cl. 423/448; 423/414; 423/460

(57) ABSTRACT

A composition of matter comprises a carbon-containing matrix. The carbon-containing matrix may comprise one or more carbon materials selected from the group comprising graphite crystalline carbon materials, carbon powder, carbon fibers, artificial graphite powder, and combinations thereof. In addition, the carbon-containing matrix comprises a plurality of pores. The composition of matter also comprises a reactive additive that is not a metal pressure disposed within at least a portion of the plurality of pores.

### CROSS-REFERENCE TO RELATED APPLICATION

This application claims the benefit under 35 U.S.C. §119(e)(1) of U.S. Provisional Application No. 61/184,549, filed Jun. 5, 2009, which is hereby incorporated by reference.

### SUMMARY

This application is directed to functionalizing pores of a carbon-containing matrix. The instant composition of matter is constructed from a carbon-containing matrix. The carbon-containing matrix may contain at least one type of carbon material, such as graphite crystalline carbon materials, carbon powder, and artificial graphite powder, carbon fibers, and combinations thereof. The carbon-containing matrix may be formed as a block, a cloth, a sheet, or a thin plate. The carbon-containing matrix may also be amorphous. In addition, the carbon-containing matrix comprises a plurality of pores. A reactive additive that is not a metal partially fills at least a portion of the plurality of pores of the carbon-containing matrix, which functionalizes the pores of the carbon-containing matrix. The carbon-containing matrix with functionalized pores may serve as a filter or be utilized as storage for certain materials.

The reactive additive may be disposed within at least a portion of the pores of the carbon-containing matrix via a chemical reaction, such as via a high pressure impregnation reaction. For example, one or more pre-cursors may be disposed within the pores of the carbon-containing matrix to react with carbon of the carbon-containing matrix to form the reactive additive within the pores of the carbon-containing matrix. Pressure and/or heat may be applied to initiate one or more reactions that form the reactive additive within the pores of the carbon-containing matrix based on the one or more pre-cursors. The reactive additive may also be disposed within the pores of the carbon-containing matrix via a high pressure impregnation process, such as the high pressure impregnation process described in U.S. Pat. No. 6,649,265, which is incorporated by reference herein.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and elements.

FIGS. 1A and 1B show a Scanning Electron Microscope (SEM) image of higher quality acicular coke and lower quality coke.

FIG. 2 illustrates SEM images of coarse graphite particle structures and fine graphite particle structures.

FIG. 3 is a flow diagram showing a method for making an exemplary carbon-containing matrix.

FIG. 4 shows Transmission Electron Microscope (TEM) images of a carbon-containing matrix.

FIGS. 5A and 5B show additional TEM images of the nanographitic plates of the carbon-containing matrix.

FIGS. 6A and 6B show TEM diffraction patterns and images of the carbon-containing matrix.

FIG. 7 shows a flow diagram of a method of disposing a reactive additive within pores of a carbon-containing matrix via a chemical reaction.

FIG. 8 shows a flow diagram of a method of disposing a reactive additive within pores of a carbon-containing matrix via a high pressure impregnation process.

FIG. 9 shows applications of a carbon-containing matrix with functionalized pores.

### DETAILED DESCRIPTION

Porous carbon can be utilized in many applications. In some cases, porous carbon can be used as a filter. For example, charcoal can be processed to achieve a high degree of microporosity, such that one gram of the porous carbon has a surface area of approximately 500 m². For many applications, the large surface area of the porous carbon is relied on to filter fluids and/or gases.

Additionally, the porous carbon may be activated by charging the surface of the porous carbon with a positive charge to adsorb impurities from fluids and/or gases being filtered. In some cases, the charcoal used to form the porous carbon may be treated chemically to enhance the adsorption achieved via the porous carbon. Activated porous carbon can also be used as fuel storage to store natural gas and H₂ gas.

The instant composition of matter includes a porous carbon-containing matrix with a reactive additive disposed within at least a portion of the pores. The instant composition of matter may be formed from a process that provides flexibility in functionalizing the pores of the carbon-containing matrix for a variety of purposes. For example, a high pressure impregnation reaction may be utilized with a number of reactive additive pre-cursors to coat the pores of the carbon-containing matrix with a particular reactive additive based on a desired function for the carbon-containing matrix, such as filtering or storage. In another example, a high pressure impregnation process may be utilized to dispose a particular reactive additive within the pores of the carbon-containing matrix according to a desired function of the carbon-containing matrix.

The amount of reactive additive disposed within the pores of the carbon-containing matrix depends on process conditions, such as temperature, pressure and time, implemented during the high pressure impregnation process or the high pressure impregnation reaction process. In this way, the amount of the reactive additive disposed within the pores, such as a thickness of a coating of the pores, can be controlled by the process conditions applied. Additionally, multiple reactive additives may be disposed within the pores of the carbon-containing matrix and each of the reactive additives may perform a different function, such as storage and filtering. Further, each of the reactive additives may perform the same function with respect to different materials. For example, one reactive additive may be disposed within the pores of the carbon-containing matrix to filter one material and another reactive additive may be disposed within the pores of the carbon-containing matrix to filter another material.

The graphitic carbon of the carbon-containing matrix may be based upon industrial coke products. This carbon residue can be derived from natural sources or from refining processes, such as in the coal and petroleum industries. In some exemplary embodiments, higher quality acicular coke derived from petroleum products may be utilized to form the carbon-containing matrix.

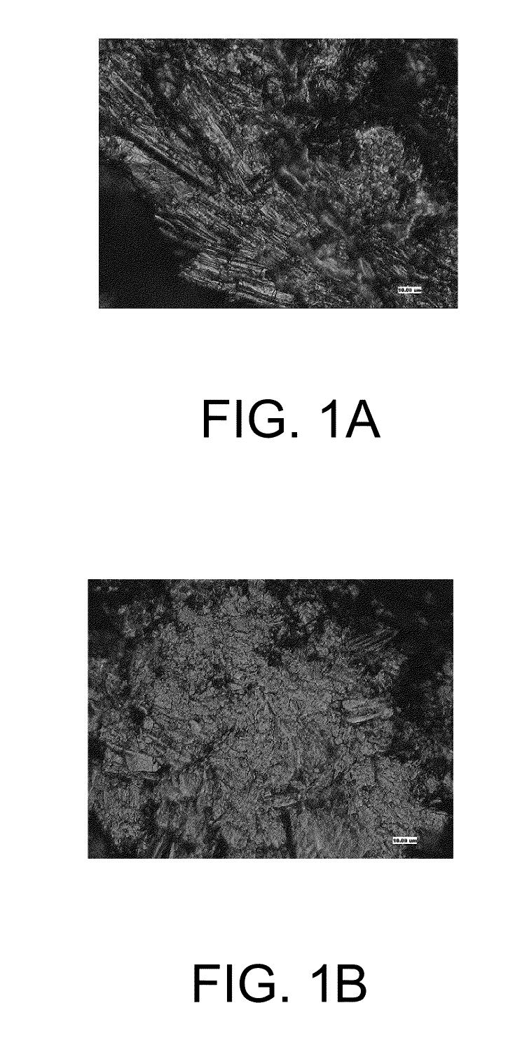

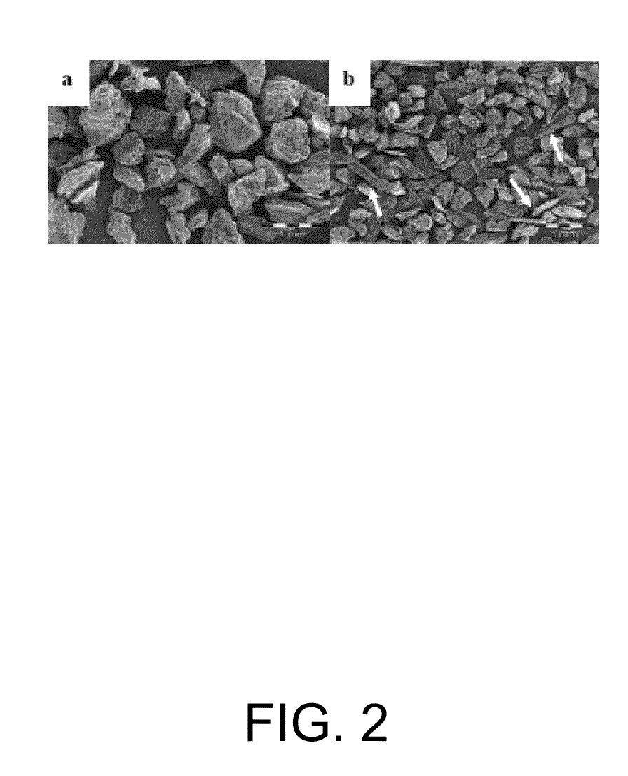

FIG. 1A shows a Scanning Electron Microscope (SEM) image of higher quality acicular coke compared to lower quality coke shown in FIG. 1B. Pitch/tar may also be added to the acicular coke to function primarily as a binder and is turned to graphitic carbon during heating at a temperature of 2600° C. or higher, typically in the range of 3200° C. to 3600° C. The raw graphite material may include coarse and fine graphite particles with an average size in the range of 0.2 mm to 2 mm. In some cases, about 10% of the particles exhibit ellipse-like shape. FIG. 2 illustrates SEM images of coarse particle structures in the picture labeled “a” and fine particle structures in the picture labeled “b” with ellipse-like particles indicated by arrows.

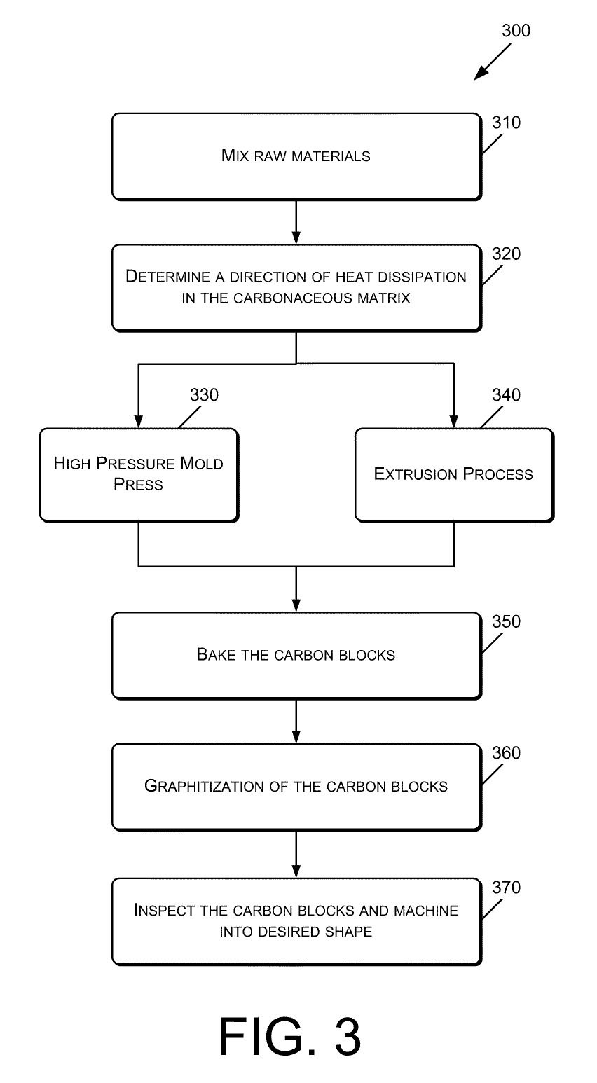

FIG. 3 is a flow diagram showing a method 300 for making a carbon-containing matrix. At 310, the raw materials are mixed together. During the mixing process, three raw materials may be used—petroleum cork, needle cork, tar (liquid), or a combination thereof. The needle cork may be used to control the shape of the carbon-containing matrix and lower the resistivity of the final carbon-containing matrix. The liquid tar may also used to control the shape of the carbon block and fill in pores of the carbon-containing matrix. The petroleum cork and the needle cork are crushed and mixed at a ratio of about 10:1, although different ratios may be used.

The mixture is then subjected to a calcining process at about 500° C. or higher to evaporate impurities, such as sulfur. The liquid tar is then dosed into the mixture. Needle cork and tar may also be used to make the carbon-containing matrix without the petroleum cork because the needle cork has a higher carbon content, lower sulfur content, lower thermal expansion coefficient, higher thermal conductivity, and is easier to form than the petroleum cork.

At 320, the method 300 includes determining a direction of heat dissipation in the carbon-containing matrix. For example, a carbon-containing matrix may dissipate heat faster in the Z-direction when the carbon-containing matrix is manufactured utilizing an extrusion process. In another example, a carbon-containing matrix may dissipate heat faster in the XY direction when the carbon-containing matrix is manufactured utilizing a high pressure mold press. When heat dissipation along the XY direction is specified, then the method 300 moves to 330 where the carbon-containing matrix is formed by placing the raw materials in a high pressure mold press at a pressure higher than 50 MPa. Otherwise, when heat dissipation along the Z direction is specified, then the method 300 moves to 340.

At 340, the raw materials mixture of petroleum cork, needle cork, and/or tar is fed into an extruding process to form carbon blocks based on the shape and size of a mold utilized to make the carbon-containing matrix. In an illustrative embodiment, a carbon mold may be cylindrical with a diameter of about 700 mm and a length of about 2700 mm having a weight of at least about 1 ton. However, the dimensions of the mold can be changed based on the capabilities of the processing facility.

The extruding process may be performed at a temperature range of 500° C. to 800° C. The force utilized to press the mixture into a column shape is about 3500 tons applied for about 30 minutes. In some instances, the extruded carbon blocks may be processed using a high pressure mold press. The carbon blocks are then transferred to a cooling water bath to cool down in order to prevent cracking.

At 350, the blocks are baked. The baking process can carbonize the tar at high temperature and eliminate volatile components. In some scenarios, the carbon blocks are transported from the cooling bath to an oven and heated at a temperature of about 1600° C. The carbon blocks may be baked for a duration in the range of 2 to 3 days. After the baking process, the surface of the carbon blocks may become rougher and porous. In addition, the diameter of the carbon block may decrease by about 10 mm.

At 360, graphitization takes place by heating the carbon block at a temperature in a range of 3200° C. to 3600° C. In some embodiments, graphitization will start at about 2600° C. with higher quality graphite forming at about 3200° C. In particular, at about 3000° C., stacking of graphitic plates of the carbon block may become parallel and turbostatic disorder decreases or is eliminated.

In some cases, the carbon block may be heated to a lower temperature to produce crystallized graphite if the heating occurs at higher pressures. The carbon blocks may be heated for about 2-3 days. During the heating process, sulfur and volatile components of the carbon block may be reduced or completely eliminated.

At 370, the carbon blocks are inspected and machined into a desired shape. For example, electrical properties of the carbon blocks may be tested and mechanical cracking or visually identifiable defects are checked prior to the next stages of production. After testing, the carbon-containing matrix may then be machined to specific shapes according to the use of the carbon blocks.

The carbon-containing matrix may include various forms of carbon and trace amounts of other materials. For example, the carbon-containing matrix may include graphite crystalline carbon materials, carbon powder, artificial graphite powder, carbon fibers, or combinations thereof. The carbon-containing matrix block may have a density in a range of 1.6 g/cm³ to 1.9 g/cm³. In addition, the resistivity of the carbon block may be in a range between 4 μΩm to 10 μΩm. In some instances, the resistivity of the carbon-containing matrix is about 5 μΩm. A lower resistivity of the carbon block may indicate better alignment of the graphitic sheets of the carbon-containing matrix, which may also provide a higher thermal conductivity.

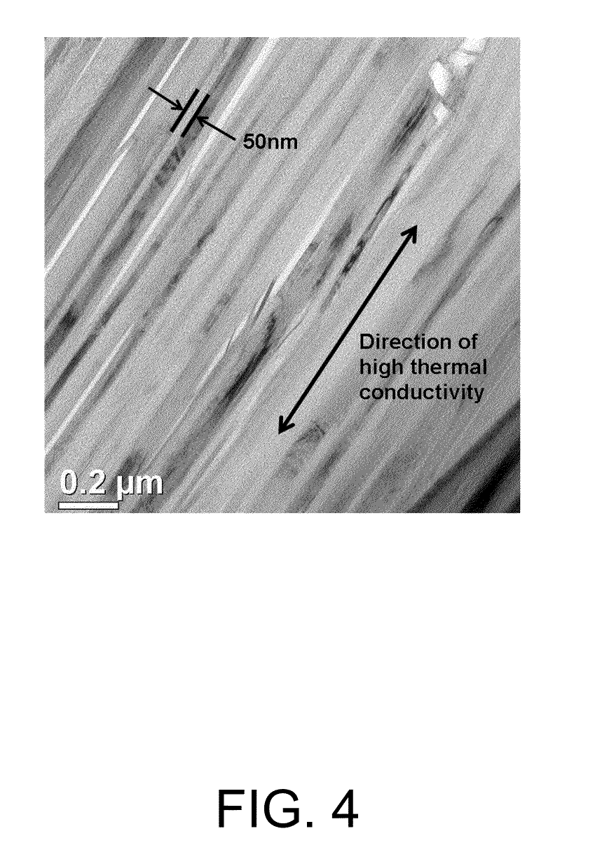

FIG. 4 shows Transmission Electron Microscope (TEM) images of the carbon-containing matrix. The TEM images of FIG. 4 indicate the formation of stacks of graphitic plates, with sizes less than about 100 nm. FIG. 4 shows a specific example of a graphitic plate having a thickness of about 50 nm. The direction of the high thermal conductivity are along the long axis as shown by the arrows of FIG. 4.

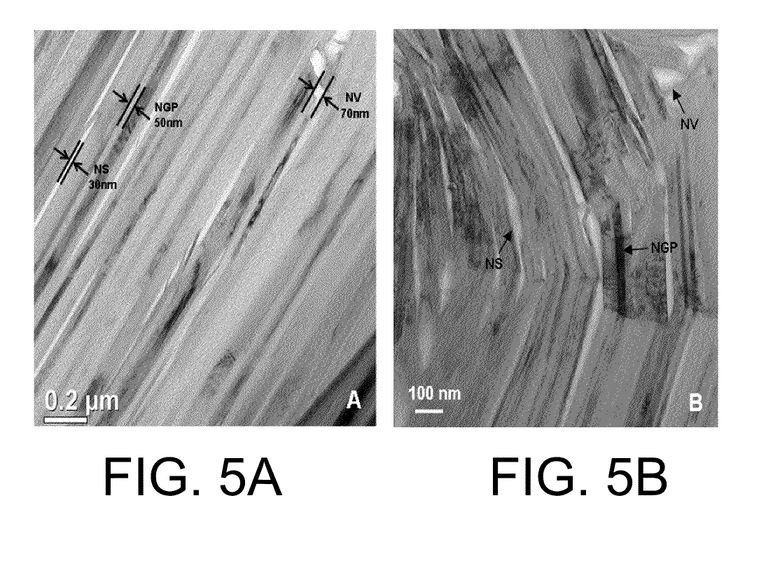

FIGS. 5A and 5B show additional TEM images of the nanographitic plates (labeled as “NGP”) of the carbon-containing matrix. The plates are oriented generally in the direction of the extrusion (FIG. 5A) and the direction of the press process (FIG. 5B). The ordered stacks of the nanographitic plates may promote efficient heat transfer in the direction of the long axis of the plates. FIGS. 5A and 5B also show nanovoids (labeled “NV”) and nanoslits (labeled “NS”), which are artifacts of the manufacturing process using carbon based particles. FIGS. 5A and 5B indicate nanovoids having a thickness of about 70 nm and nanoslits having a thickness of about 30 nm.

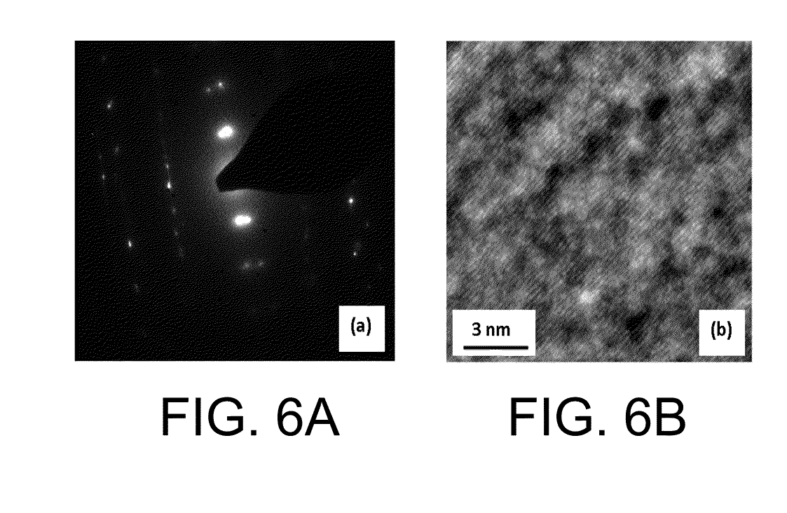

FIGS. 6A and 6B show TEM diffraction patterns and images of the carbon-containing matrix. The TEM diffraction pattern of FIG. 6A and the TEM image of FIG. 6B indicate the crystallinity and graphitic nature of the carbon-containing matrix formed during an extrusion process. In particular, FIG. 6A shows the diffraction pattern produced as the electrons interact with the crystalline lattice of the graphite material. Additionally, FIG. 6B, shows the lattice structure of the graphitic plates.

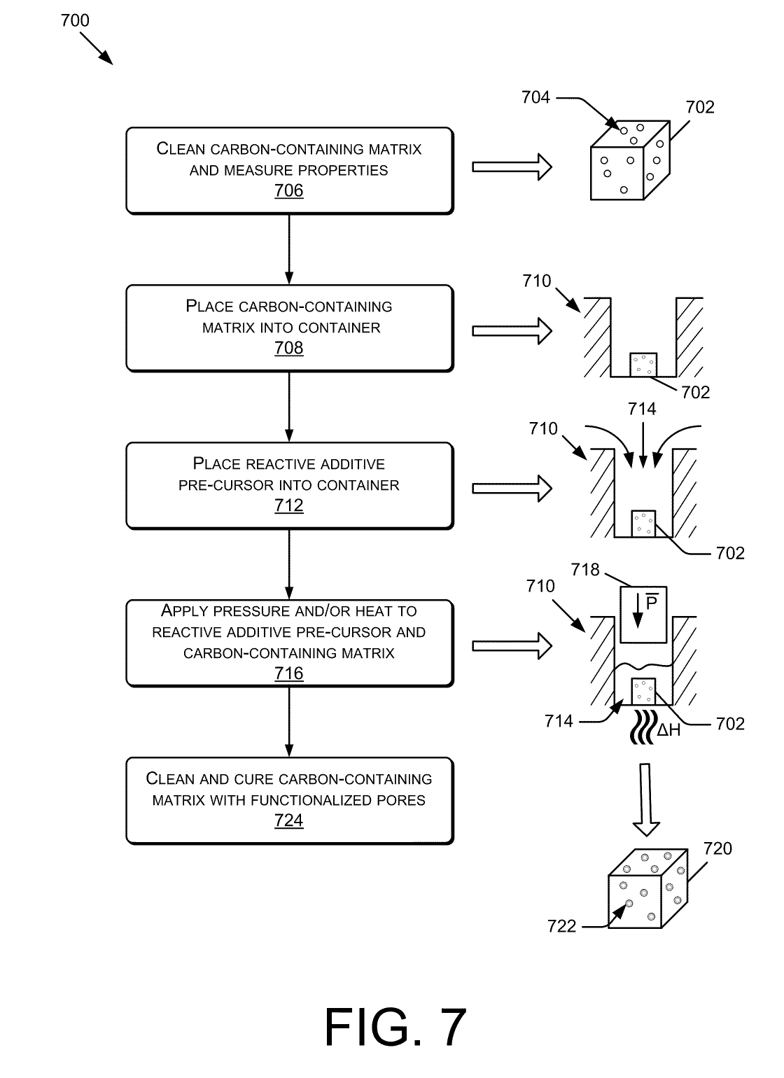

FIG. 7 shows a flow diagram of a method 700 of disposing a reactive additive within a carbon-containing matrix 702 having a number of pores 704 via a chemical reaction. The pores 704 of the carbon-containing matrix 702 may be partially filled with the reactive additive. For example, the reactive additive may form a coating over the pores 704 of the carbon-containing matrix 702.

The carbon-containing matrix 702 may be formed as a block, a cloth, a plate, or a sheet. The carbon-containing matrix 702 may also be amorphous. In a particular example, the carbon-containing matrix 702 may include one or more plates formed by cutting a carbon block. The thickness of the plates may be less than about 1 mm.

In some cases, the carbon containing matrix 702 may be a carbon-containing matrix produced via the method 300 of FIG. 3. Additionally, the carbon-containing matrix 702 may be activated by charging the surface of the carbon-containing matrix 702, such as by placing a positive charge on molecules of the surface of the carbon-containing matrix 702.

At 706, the carbon-containing matrix 702 is cleaned and the physical and thermal properties of the carbon-containing matrix 702 are measured. For example, the carbon-containing matrix 702 may be cleaned with an N₂ gun. At 708, the carbon-containing matrix 702 is placed in a container 710, such as a mold of a reactor press, and at 712, a reactive additive pre-cursor 714 is placed in the container 710. The reactive additive pre-cursor 714 may be a solid, liquid, or gas. In addition, the reactive additive pre-cursor 714 may comprise a metal, an alloy, an organic polymer, and combinations thereof.

The reactive additive pre-cursor 714 placed in the container depends on the desired function of the pores 704 of the carbon-containing matrix 702. For example, when the pores 704 are to be used as storage for hydrogen, the reactive additive pre-cursor 714 may be one or more metal hydride pre-cursors. In addition, when the pores 704 are to be used as a water filter, the reactive additive pre-cursor 714 may be a bio-reactive pre-cursor used to form a reactive additive to filter bacteria out of the water.

At 716, energy in the form of pressure and/or heat is applied to the reactive additive pre-cursor 714 and the carbon-containing matrix 702. For example, a die 718 may be applied to the reactive additive pre-cursor 714 and the carbon-containing matrix 702. In some cases, when the reactive additive pre-cursor 714 is a solid or a liquid, the pressures applied to the reactive additive pre-cursor 714 and the carbon-containing matrix 702 are at least above 500 psi. When the reactive additive pre-cursor 714 is a gas, pressures lower than about 500 psi, such as a partial vacuum may be applied to the reactive additive pre-cursor 714 and the carbon-containing matrix 702. Further, in certain scenarios, the pressures applied to the reactive additive pre-cursor 714 and the carbon-containing matrix 702 may range from 10 MPa to 50 MPa. Temperatures applied to the reactive additive pre-cursor 714 and the carbon-containing matrix 702 may range from 200° C. to 1000° C.

In some cases, the reactivity of the reactive additive pre-cursor 714 may affect the pressure and/or temperature applied to the reactive additive pre-cursor 714 and the carbon-containing matrix 702 in the container 710. Additionally, the amount of the reactive additive to be disposed within the pores 704 may affect the pressure and/or temperature applied to the reactive additive pre-cursor 714 and the carbon-containing matrix 702 in the container 710. An amount of time that the pressure and/or temperature are applied to the reactive additive pre-cursor 714 and the carbon-containing matrix 702 may also affect the volume of the pores 704 filled with the reactive additive.

While the pressure and/or temperature are applied to the carbon-containing matrix 702 and the reactive additive pre-cursor 714, a chemical reaction may take place and end products including one or more reactive additives may be formed within the pores 704 of the carbon-containing matrix 702 to produce a carbon-containing matrix with functionalized pores 720. At least a portion of the pores 704 of the carbon-containing matrix 702 are partially filled with a reactive additive 722. In some instances, the reactive additive 722 is a non-metal. At 724, the carbon-containing matrix with functionalized pores 720 is cleaned and cured.

In some cases, multiple reactive additives 722 may be disposed in the pores 704 of the carbon-containing matrix 702. The multiple reactive additives 722 may be disposed within the pores 704 of the carbon-containing matrix 702 via a single chemical reaction between a single reactive additive pre-cursor 714 and the carbon of the carbon-containing matrix 702. The multiple reactive additives 722 may also be disposed within the pores 704 of the carbon-containing matrix 702 via multiple chemical reactions involving multiple reactive additive pre-cursors 714, the carbon of the carbon-containing matrix 702, and combinations thereof. Each of the chemical reactions may be initiated by applying different temperatures and pressures to the carbon-containing matrix 702 and the reactive additive pre-cursors 714. In some instances, each of the reactive additives 722 may perform a single function, while in other instances the reactive additives 722 may perform multiple functions.

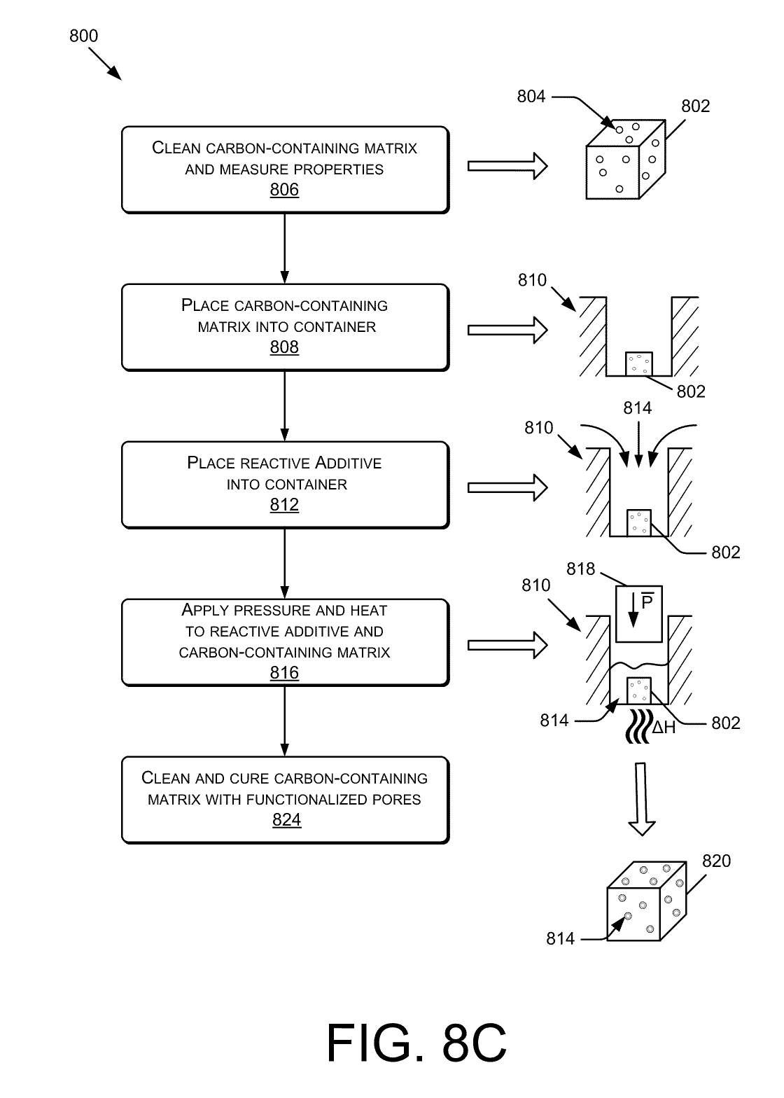

FIG. 8 shows a flow diagram of a method 800 of disposing a reactive additive within a carbon-containing matrix 802 having a number of pores 804 via a high pressure impregnation process. The pores 804 of the carbon-containing matrix 802 may be partially filled with the reactive additive. For example, the reactive additive may form a coating over the pores 804 of the carbon-containing matrix 802.

The carbon-containing matrix 802 may be formed as a block, a plate, a sheet, or a cloth. Additionally, the carbon-containing matrix 802 may have an amorphous shape. In a particular example, the carbon-containing matrix 802 may include one or more plates formed by cutting a carbon block. The thickness of the plates may be less than about 1 mm. In some cases, the carbon containing matrix 802 may be a carbon-containing matrix produced via the method 300 of FIG. 3. Additionally, the carbon-containing matrix 802 may be activated by charging the surface of the carbon-containing matrix 802, such as placing a positive charge on molecules of the surface of the carbon-containing matrix 802.

At 806, the carbon-containing matrix 802 is cleaned and the physical and thermal properties of the carbon-containing matrix 802 are measured. For example, the carbon-containing matrix 802 may be cleaned with an N₂ gun. At 808, the carbon-containing matrix 802 is placed in a container 810, such as a mold of a reactor press, and at 812, a reactive additive 814 is placed in the container 810. The reactive additive 814 may be a solid, liquid, or gas. The reactive additive 814 may be a non-metal, such as an organic polymer. In addition, the reactive additive 814 may comprise a metal, an alloy, and combinations thereof. The reactive additive 814 placed in the container depends on the desired function of the pores 804 of the carbon-containing matrix 802

At 816, the container 810 is pressurized and heated. For example, a die 818 may be applied to the reactive additive 814 and the carbon-containing matrix 802. The pressures applied to the reactive additive 814 and the carbon-containing matrix 802 may range from 10 MPa to 50 MPa. When the reactive additive 814 is a solid or a liquid, the pressures applied to the reactive additive 814 and the carbon-containing matrix 802 are at least above 500 psi. When the reactive additive 814 is a gas, pressures lower than about 500 psi, such as a partial vacuum may be applied to the reactive additive 814 and the carbon-containing matrix 802. Further, in certain scenarios, the pressures applied to the reactive additive pre-cursor 814 and the carbon-containing matrix 802 may range from 10 MPa to 50 MPa. Temperatures applied to the reactive additive 814 and the carbon-containing matrix 802 may range from 200° C. to 1000° C.

While the pressure and/or temperature are applied to the carbon-containing matrix 802 and the reactive additive 814, at least a portion of the pores 804 of the carbon-containing matrix 802 are partially filled with the reactive additive 814. In some cases, the amount of the reactive additive 814 to be disposed within the pores 804 may affect the pressure and/or temperature applied to the reactive additive 814 and the carbon-containing matrix 802 in the container 810. At 824, a carbon-containing matrix with functionalized pores 820 is cleaned and cured.

Further, multiple reactive additives 814 may be disposed within the pores 804 of the carbon-containing matrix 802. Each of the reactive additives 814 may perform a different function, such as storage or filtering. In addition, the reactive additives 814 may each perform multiple functions. The reactive additives 814 may also perform the same function, but with respect to different materials. For example, the reactive additives 814 may be filter materials, such as an amine and a carboxylic acid, that filter different substances. Different temperatures and pressures may be applied to the carbon-containing matrix 802 and the reactive additives 814 to dispose each respective reactive additive 814 within the pores 804.

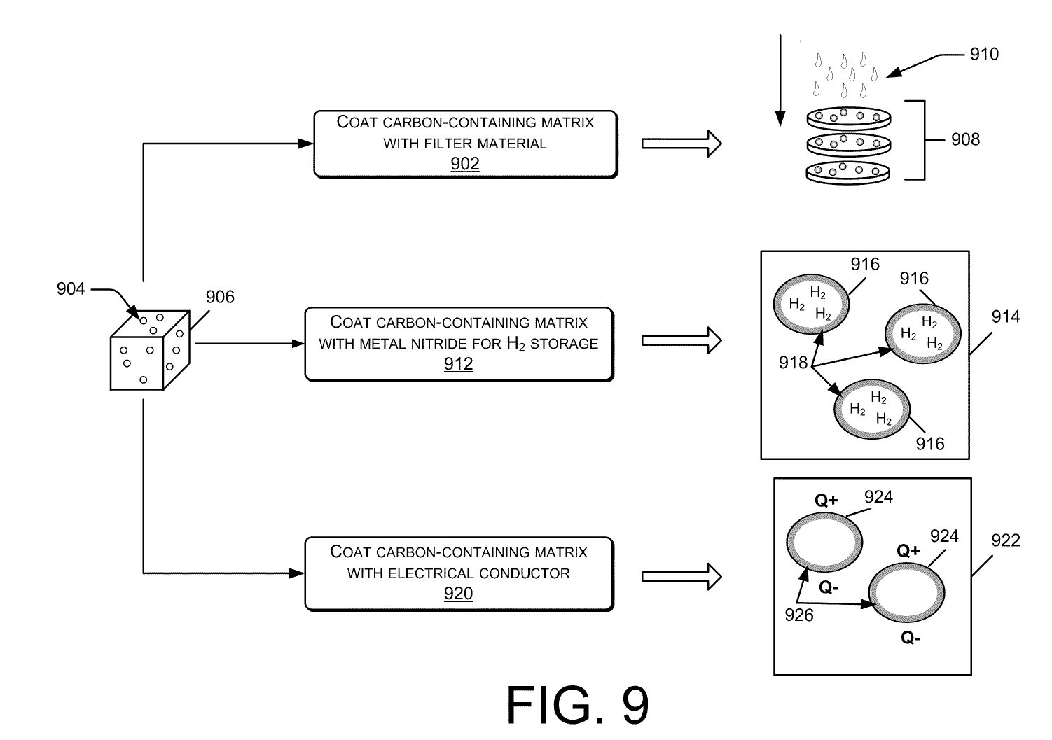

FIG. 9 shows applications of a carbon-containing matrix with functionalized pores. In particular, at 902, pores 904 of a carbon-containing matrix 906 are coated with a filter material. The filter material may comprise the reactive additives 722 and 814 of FIGS. 7 and 8. Additionally, the filter material can deposit reactive chemical functional groups on the surface of the carbon-containing matrix 906. In the particular example shown in FIG. 9, the carbon-containing matrix 906 is formed as a number of plates 908. A liquid 910 is discharged through the plates 908 and certain materials are filtered out of the liquid 910 depending on the filter material disposed within the pores 904. For example, when the liquid 910 is water, materials such as chlorine and bacteria, may be filtered out by the plates 910.

In some alternative implementations, the carbon-containing matrix 906 may be formed into the plates 908 and function as a filter for liquids, such as the liquid 910, without the filter material being coated on the pores 904 of the carbon-containing matrix 906. Thus, a bare carbon-containing matrix, such as a carbon-containing matrix formed via the method 300 of FIG. 3 may be utilized as a filter for liquids. Additionally, in some scenarios, the bare carbon-containing matrix may include activated carbon.

At 912, the pores 904 of the carbon-containing matrix 906 are coated with a metal nitride in order to store H₂ gas in the pores 904. A sample cross-section 914 of the carbon-containing matrix 906 shows three pores 916 coated with a metal hydride 918. Additionally, the sample cross-section 914 indicates storage of H₂ gas in the pores 916. The metal hydride 918 may include hydrides of Mg, LiH, NaBH₄, LiAlH₄, LaNi₅H₆, TiFeH₂, LiNH₂, NaBH₄, LiBH₄, or combinations thereof. In some cases, the pores 904 may be coated with H₃NBH₃.

At 920, the pores 904 of the carbon-containing matrix 906 are coated with an electrical conductor in order to function as capacitor electrodes or battery electrodes. A sample cross-section 922 of the carbon-containing matrix 906 shows two pores 924 coated with an electrical conductor 926. As shown in FIG. 9, portions of the electrical conductor 926 may carry a positive charge or a negative charge.

1. A composition of matter comprising:
a carbon-containing matrix comprising a plurality of pores; and
a reactive additive that is not a metal that is pressure disposed within at least a portion of the plurality of pores, the reactive additive partially filling the at least the portion of the plurality of pores.

2. The composition of matter of claim 1, wherein the carbon-containing matrix is constructed from at least one type of carbon material selected from the group comprising graphite crystalline carbon materials, carbon powder, artificial graphite powder, carbon fibers, and combinations thereof.

3. The composition of matter of claim 1, wherein H₂ gas is disposed within the at least a portion of the plurality of pores.

4. The composition of matter of claim 1, wherein the reactive additive comprises an electrical conductor.

5. The composition of matter of claim 1, wherein the reactive additive is disposed as a coating within the at least a portion of the plurality of pores.

6. The composition of matter of claim 1, wherein the carbon-containing matrix comprises activated carbon.

7. The composition of matter of claim 1, wherein the reactive additive is formed from a high pressure impregnation reaction.

8. The composition of matter of claim 1, wherein the reactive additive is disposed within the at least a portion of the plurality of pores by high pressure impregnation.

9. An article of manufacture formed by machining the composition of matter of claim 1 into a thin plate.

10. A method of making the composition of matter of claim 1 comprising:
providing the carbon-containing matrix and a reactive additive pre-cursor; and
initiating a reaction to form the reactive additive within the at least a portion of the plurality of pores of the carbon-containing matrix.

11. The method of claim 10, wherein the carbon-containing matrix and reactive additive pre-cursor are pressurized to a pressure greater than about 500 psi.

12. The method of claim 10, wherein the reaction is initiated by raising a temperature of the carbon-containing matrix and the reactive additive pre-cursor to the range of 200° C. to 1000° C.

13. The method of claim 10, wherein the carbon-containing matrix includes a plurality of plates.

14. The method of claim 13, wherein the plurality of plates have a thickness of less than about 1 mm.

15. The method of claim 10, further comprising curing the composition of matter of claim 1.

16. The method of claim 10, further comprising forming a filter from the composition of matter of claim 1.

17. A method of making the composition of matter of claim 1 comprising:
providing the carbon-containing matrix and a reactive additive that is not a metal; and
pressurizing the carbon-containing matrix and the reactive additive to a pressure greater than about 500 psi at a temperature in the range of 200° C.-1000° C.

18. A composition of matter made by a method comprising:
providing a carbon-containing matrix including a plurality of pores and a plurality of reactive additive pre-cursors, the carbon-containing matrix comprising one or more materials selected from the group comprising graphite crystalline carbon materials, carbon powder, artificial graphite powder, carbon fibers, and combinations thereof; and
initiating a plurality of reactions between the plurality of reactive additive pre-cursors, carbon of the carbon-containing matrix, and combinations thereof, to dispose a plurality of reactive additives that are not metals within at least a portion of the plurality of pores of the carbon-containing matrix, each of the plurality of reactions is initiated by applying corresponding pressures and temperatures required to initiate each respective reaction.

19. An article of manufacture comprising:
a carbon-containing matrix formed as a filter for liquids, the carbon-containing matrix including a plurality of pores and the carbon-containing matrix constructed from one or more materials selected from the group comprising graphite crystalline carbon materials, carbon powder, artificial graphite powder, carbon fibers, and combinations thereof.

20. The article of manufacture of claim 19, wherein a reactive additive that is not a metal is disposed within at least a portion of the plurality of pores of the carbon-containing matrix.

21. The article of manufacture of claim 20, wherein the reactive additive is disposed as a coating within the at least a portion of the plurality of pores.

22. The article of manufacture of claim 20, wherein the reactive additive is formed from a high pressure impregnation reaction.

23. The article of manufacture of claim 20, wherein the reactive additive is disposed within the at least a portion of the plurality of pores by high pressure impregnation.
